(19) United States
(12) Patent Application Publication
(10) Pub. No.: US 2026/0214625 A1
(43) Pub. Date: Jul. 23, 2026

(54) FREQUENCY HOPPING PATTERN ASSOCIATED WITH REFERENCE SIGNAL FOR POSITIONING CONFIGURATION

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 19/144,218

(22) PCT Filed: Jan. 30, 2024
(86) PCT No.: PCT/US2024/013552

§ 371 Date: Jun. 27, 2025

(30) Foreign Application Priority Data
Feb. 10, 2023 (GR) 20230100107

(51) Int. Cl. H04W 64/00; H04L 5/00

(52) U.S. Cl. CPC H04W 64/00; H04L 5/0012; H04L 5/0044

(57) ABSTRACT

Disclosed are techniques for communication. In an aspect, a wireless node (e.g., such as a user equipment (UE) or gNB) receives (e.g., from a position estimation entity a reference signal for positioning (RS-P) configuration associated with a position estimation session of a user equipment (UE), the RS-P configuration associated with an RS-P frequency hopping pattern that is based on a set of RS-P frequency hopping pattern parameters. The wireless node further performs one or more actions associated with the position estimation session of the UE based on the RS-P configuration. For example, the wireless node may transmit (e.g., and the position estimation entity may receive) a measurement report that is based on one or more RS-P measurements performed in accordance with the RS-P configuration.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a wireless node includes receiving a reference signal for positioning (RS-P) configuration associated with a position estimation session of a user equipment (UE), the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and performing one or more actions associated with the position estimation session of the UE based on the RS-P configuration.

In an aspect, a method of operating a position estimation entity includes transmitting a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and receiving a measurement report that is based on one or more RS-P measurements performed in accordance with the RS-P configuration.

In an aspect, a wireless node includes a memory; and at least one processor communicatively coupled to the memory, the at least one processor configured to: receive a reference signal for positioning (RS-P) configuration associated with a position estimation session of a user equipment (UE), the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and perform one or more actions associated with the position estimation session of the UE based on the RS-P configuration.

In an aspect, a position estimation entity includes a memory; and at least one processor communicatively coupled to the memory, the at least one processor configured to: transmit a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and receive a measurement report that is based on one or more RS-P measurements performed in accordance with the RS-P configuration.

In an aspect, a wireless node includes means for receiving a reference signal for positioning (RS-P) configuration associated with a position estimation session of a user equipment (UE), the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and means for performing one or more actions associated with the position estimation session of the UE based on the RS-P configuration.

In an aspect, a position estimation entity includes means for transmitting a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and means for receiving a measurement report that is based on one or more RS-P measurements performed in accordance with the RS-P configuration.

In an aspect, a non-transitory computer-readable medium storing computer-executable instructions that, when executed by a wireless node, cause the wireless node to: receive a reference signal for positioning (RS-P) configuration associated with a position estimation session of a user equipment (UE), the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and perform one or more actions associated with the position estimation session of the UE based on the RS-P configuration.

In an aspect, a non-transitory computer-readable medium storing computer-executable instructions that, when executed by a position estimation entity, cause the position estimation entity to: transmit a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and receive a measurement report that is based on one or more RS-P measurements performed in accordance with the RS-P configuration.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 is a diagram illustrating various uplink channels within an example uplink slot, according to aspects of the disclosure.

FIG. 7 is a diagram of an example of frequency domain positioning reference signal (PRS) stitching, according to aspects of the disclosure.

FIG. 8 illustrates a frequency hopping scheme in accordance with an aspect of the disclosure.

FIG. 9 illustrates a frequency hopping scheme in accordance with another aspect of the disclosure.

FIG. 10 illustrates a frequency hopping scheme, in accordance with aspects of the disclosure.

FIG. 11 illustrates an exemplary process of communications according to an aspect of the disclosure.

FIG. 12 illustrates an exemplary process of communications according to an aspect of the disclosure.

FIG. 13 illustrates a frequency hopping pattern, in accordance with aspects of the present disclosure.

FIG. 14 illustrates a frequency hopping pattern associated with an example implementation of the processes of FIGS. 11-12, respectively, in accordance with aspects of the present disclosure.

FIG. 15 illustrates a SRS-PRS-coupled frequency hopping scheme associated with an example implementation of the processes of FIGS. 11-12, respectively, in accordance with aspects of the present disclosure.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Particular aspects of the subject matter described in this disclosure can be implemented to realize one or more of the following potential advantages. In some examples, aspects of the disclosure are directed to defining an overlap BW amount between frequency hops of respective frequency hopping instance(s) of an RS-P resource (e.g., DL PRS resource or UL SRS resource). Such aspects may provide various technical advantages, such as improved phase tracking between frequency hops which facilitates RS-P “stitching” so as to improve position estimation accuracy, latency, and so on, particularly for UE types such as RedCap UEs.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

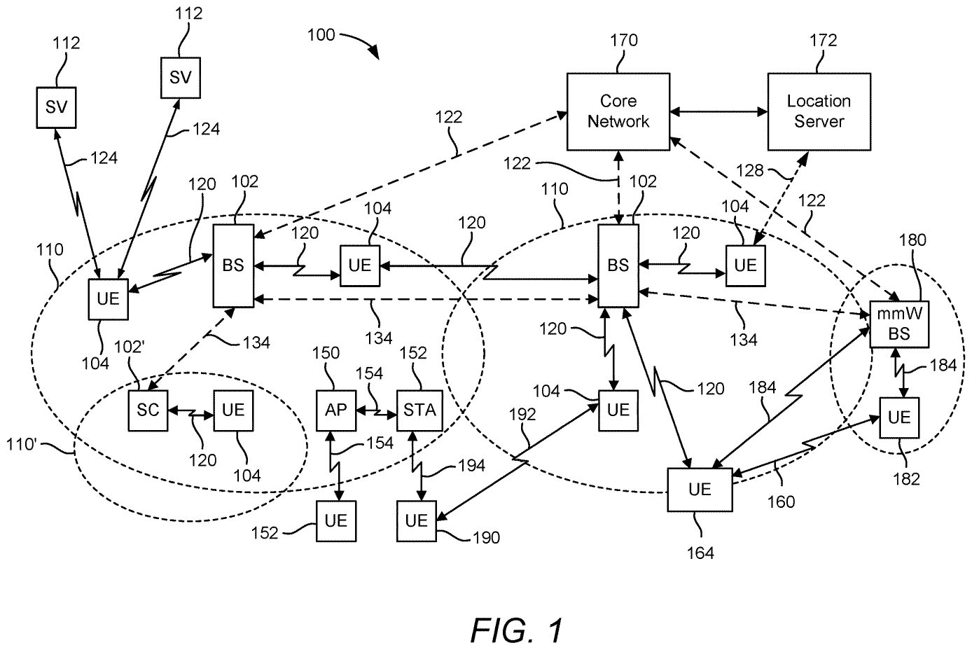

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mm W frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mm W/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mm W and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mm W base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

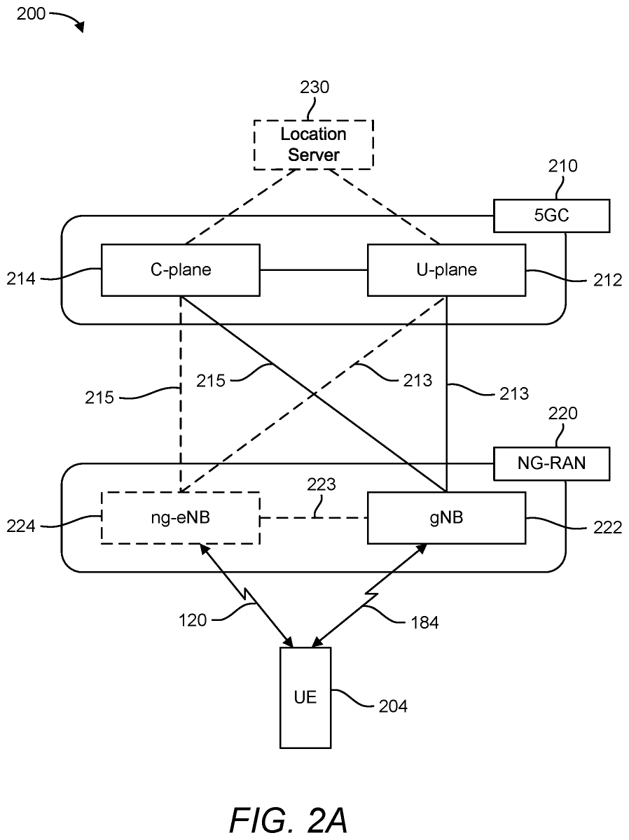

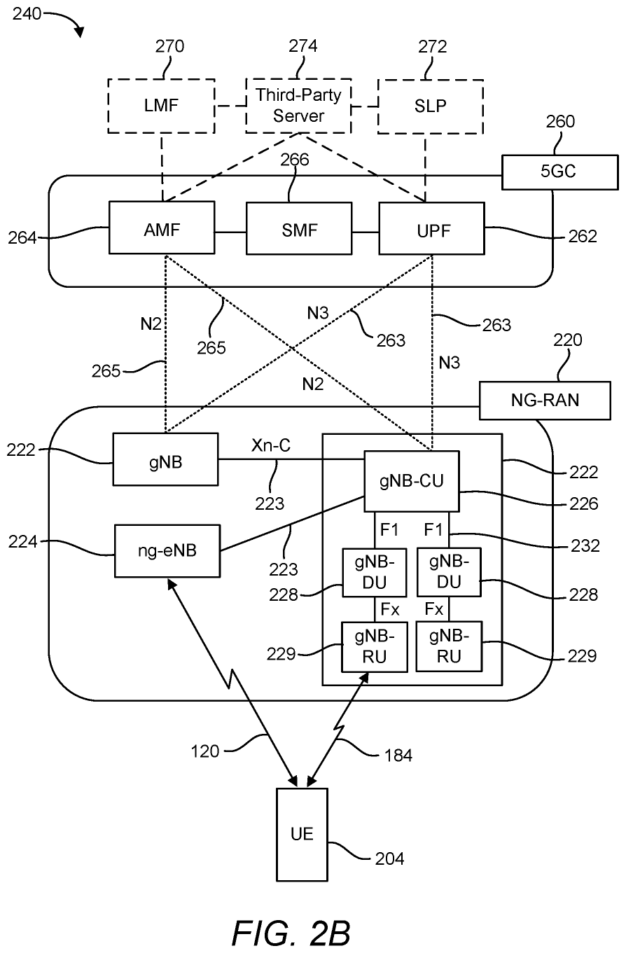

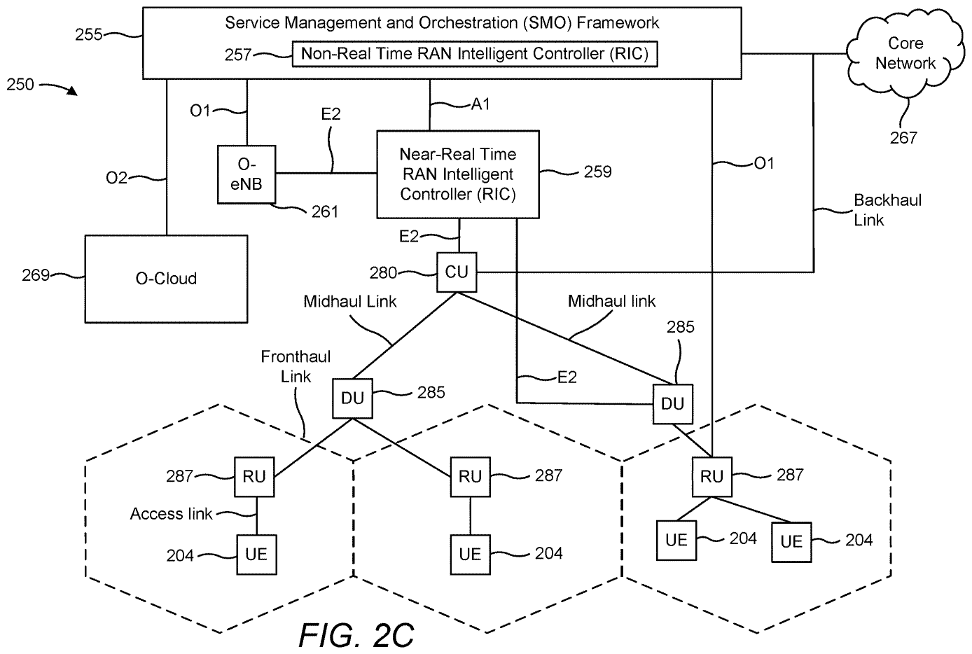

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network. 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework. 255, or both). A CU 280 may communicate with one or more distributed units (DUs) 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

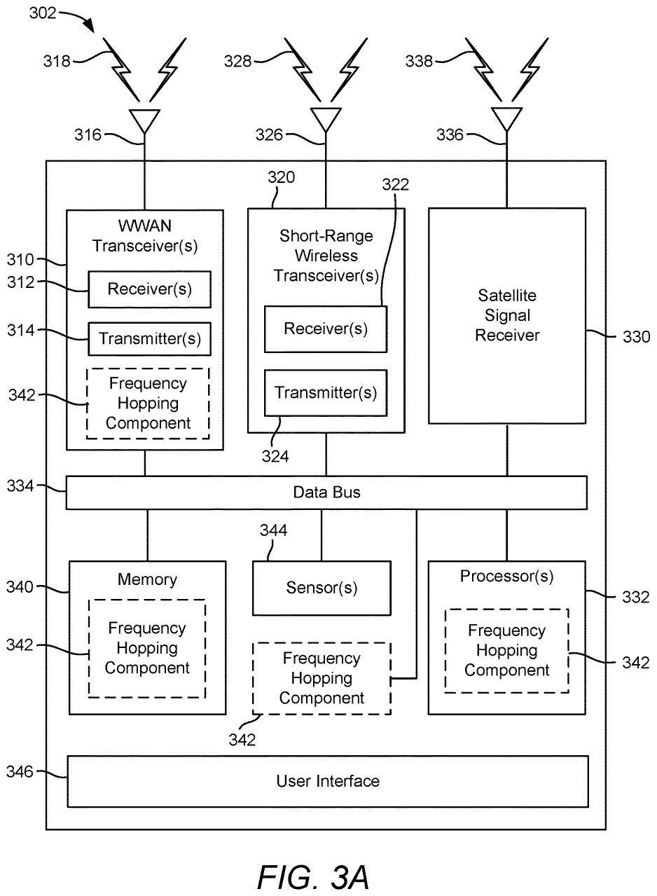

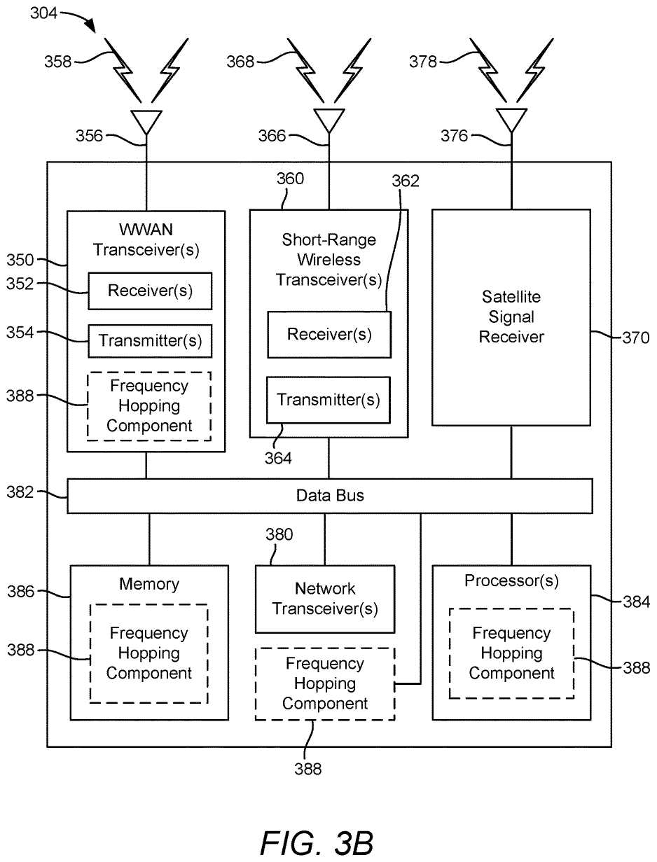

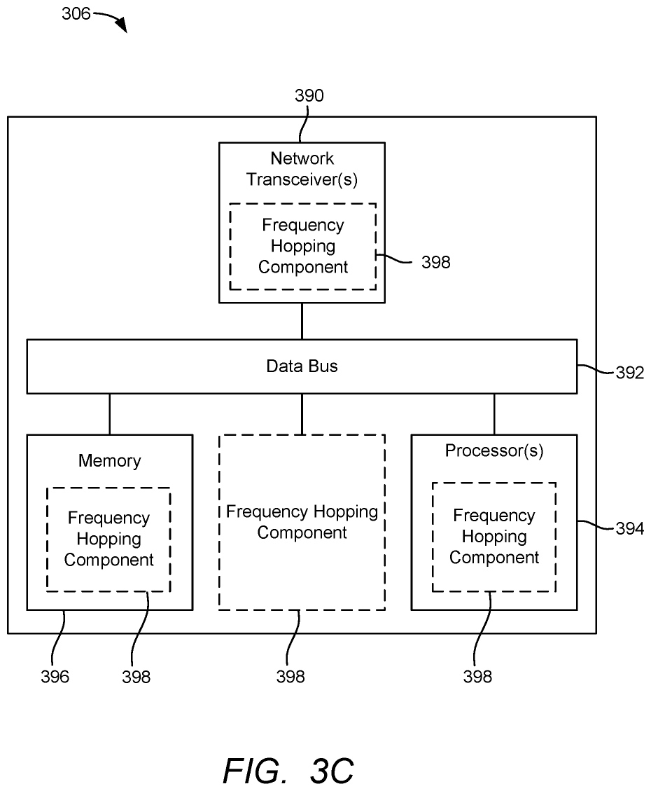

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum), The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include frequency hopping component 342, 388, and 398, respectively. The frequency hopping component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the frequency hopping component 342, 388, and 398 may be external to the processors 332, 384, and 394 (e.g., part of a modem processing system, integrated with another processing system, etc.). Alternatively, the frequency hopping component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the frequency hopping component 342, which may be, for example, part of the one or more WWAN transceivers 310, the memory 340, the one or more processors 332, or any combination thereof, or may be a standalone component. FIG. 3B illustrates possible locations of the frequency hopping component 388, which may be, for example, part of the one or more WWAN transceivers 350, the memory 386, the one or more processors 384, or any combination thereof, or may be a standalone component. FIG. 3C illustrates possible locations of the frequency hopping component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station.” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the frequency hopping component 342, 388, and 398, etc.

In some designs, the network entity 306 may be implemented as a core network component. In other designs, the network entity 306 may be distinct from a network operator operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

Note that the UE 302 illustrated in FIG. 3A may represent a “low-tier” UE or a “premium” UE. As described further below, while low-tier and premium UEs may have the same types of components (e.g., both may have WWAN transceivers 310, processing systems 332, memory components 340, etc.), the components may have different degrees of functionality (e.g., increased or decreased performance, more or fewer capabilities, etc.) depending on whether the UE 302 corresponds to a low-tier UE or a premium UE.

UEs may be classified as low-tier UEs (e.g., wearables, such as smart watches, glasses, rings, etc.) and premium UEs (e.g., smartphones, tablet computers, laptop computers, etc.). Low-tier UEs may alternatively be referred to as reduced-capability NR UEs, reduced-capability UEs, NR light UEs, light UEs, NR super light UEs, or super light UEs. Premium UEs may alternatively be referred to as full-capability UEs or simply UEs. Low-tier UEs generally have lower baseband processing capability, fewer antennas (e.g., one receiver antenna as baseline in FR1 or FR2, two receiver antennas optionally), lower operational bandwidth capabilities (e.g., 20 MHz for FR1 with no supplemental uplink or carrier aggregation, or 50 or 100 MHz for FR2), only half duplex frequency division duplex (HD-FDD) capability, smaller HARQ buffer, reduced physical downlink control channel (PDCCH) monitoring, restricted modulation (e.g., 64 QAM for downlink and 16 QAM for uplink), relaxed processing timeline requirements, and/or lower uplink transmission power compared to premium UEs. Different UE tiers can be differentiated by UE category and/or by UE capability. For example, certain types of UEs may be assigned a classification (e.g., by the original equipment manufacturer (OEM), the applicable wireless communications standards, or the like) of “low-tier” and other types of UEs may be assigned a classification of “premium.” Certain tiers of UEs may also report their type (e.g., “low-tier” or “premium”) to the network. Additionally, certain resources and/or channels may be dedicated to certain types of UEs.

As will be appreciated, the accuracy of low-tier UE positioning may be limited. For example, a low-tier UE may operate on a reduced bandwidth, such as 5 to 20 MHz for wearable devices and “relaxed” IoT devices (i.e., IoT devices with relaxed, or lower, capability parameters, such as lower throughput, relaxed delay requirements, lower energy consumption, etc.), which results in lower positioning accuracy. As another example, a low-tier UE's receive processing capability may be limited due to its lower cost RF/baseband. As such, the reliability of measurements and positioning computations would be reduced. In addition, such a low-tier UE may not be able to receive multiple PRS from multiple TRPs, further reducing positioning accuracy. As yet another example, the transmit power of a low-tier UE may be reduced, meaning there would be a lower quality of uplink measurements for low-tier UE positioning.

Premium UEs generally have a larger form factor and are costlier than low-tier UEs, and have more features and capabilities than low-tier UEs. For example, with respect to positioning, a premium UE may operate on the full PRS bandwidth, such as 100 MHz, and measure PRS from more TRPs than low-tier UEs, both of which result in higher positioning accuracy. As another example, a premium UE's receive processing capability may be higher (e.g., faster) due to its higher-capability RF/baseband. In addition, the transmit power of a premium UE may be higher than that of a low-tier UE. As such, the reliability of measurements and positioning computations would be increased.

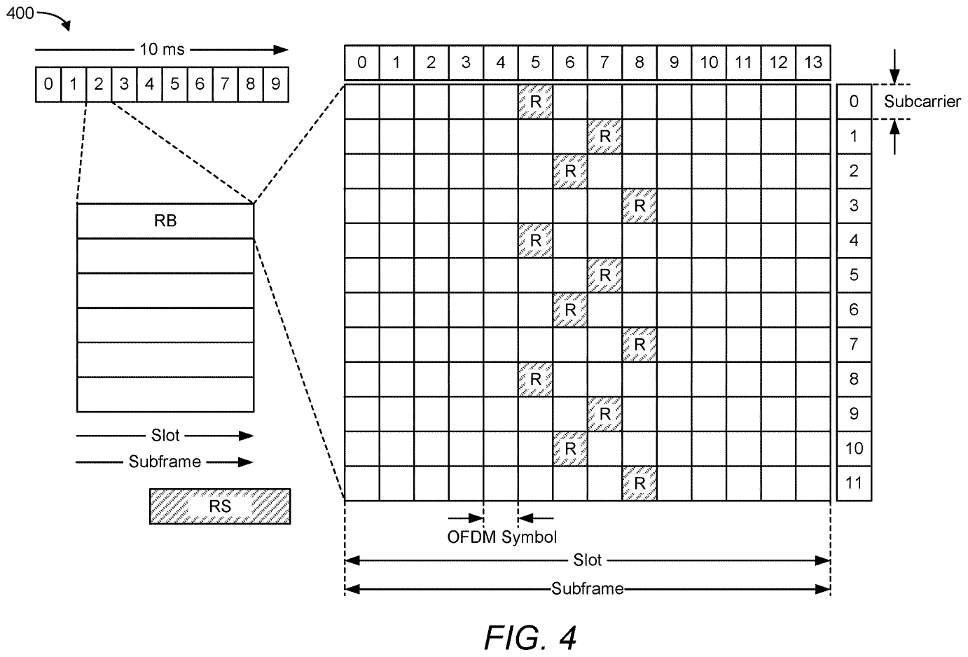

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (ρ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (ρ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 KHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

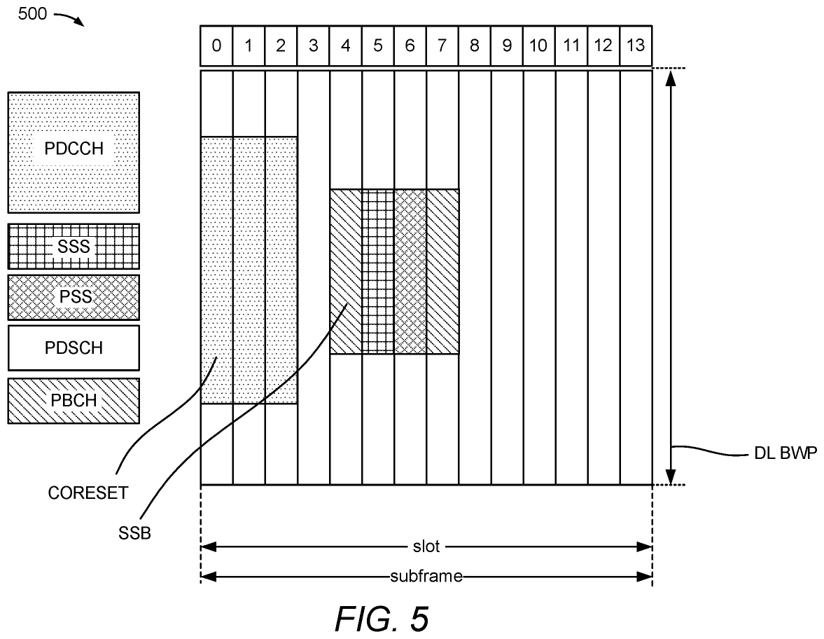

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 4); 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as a “UL-SRS” or an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

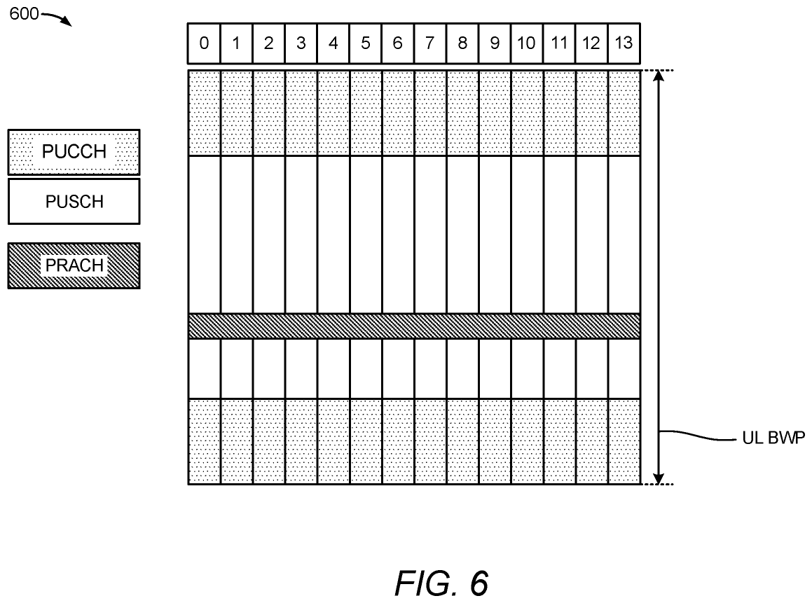

FIG. 6 is a diagram 600 illustrating various uplink channels within an example uplink slot. In FIG. 6, time is represented horizontally (on the X axis) with time increasing from left to right, while frequency is represented vertically (on the Y axis) with frequency increasing (or decreasing) from bottom to top. In the example of FIG. 6, a numerology of 15 kHz is used. Thus, in the time domain, the illustrated slot is one millisecond (ms) in length, divided into 14 symbols.

A random-access channel (RACH), also referred to as a physical random-access channel (PRACH), may be within one or more slots within a frame based on the PRACH configuration. The PRACH may include six consecutive RB pairs within a slot. The PRACH allows the UE to perform initial system access and achieve uplink synchronization. A physical uplink control channel (PUCCH) may be located on edges of the uplink system bandwidth. The PUCCH carries uplink control information (UCI), such as scheduling requests, CSI reports, a channel quality indicator (CQI), a precoding matrix indicator (PMI), a rank indicator (RI), and HARQ ACK/NACK feedback. The physical uplink shared channel (PUSCH) carries data, and may additionally be used to carry a buffer status report (BSR), a power headroom report (PHR), and/or UCI.

NR positioning techniques are expected to provide high accuracy (horizontal and vertical), low latency, network efficiency (scalability, reference signal overhead, etc.), and device efficiency (power consumption, complexity, etc.), especially for commercial positioning uses cases (including general commercial use cases and specifically (I) IoT use cases). Referring to the accuracy expectation, the accuracy of a location estimate depends on the accuracy of the positioning measurements (e.g., ToA, RSTD, Rx-Tx, etc.) of received PRS, and the larger the bandwidth of the measured PRS, the more accurate the positioning measurements.

One technique for increasing the bandwidth of PRS is aggregating PRS across the frequency domain (referred to as “frequency domain stitching”) and/or the time domain (referred to as “time domain stitching”). In frequency domain PRS stitching, PRS are transmitted (by a base station or UE) on multiple, preferably contiguous, bandwidth intervals (e.g., positioning frequency layers, bandwidth parts (BWPs), groups of contiguous PRBs, etc.) within one or more component carriers, frequency bands, or other portions of bandwidth, and the receiver (a UE or base station) measures the PRS across the (contiguous) bandwidth intervals. By spanning multiple bandwidth intervals, the effective bandwidth of the PRS is increased, resulting in increased positioning measurement accuracy. In time domain PRS stitching, the multiple bandwidth intervals also span multiple, preferably contiguous, time intervals (e.g., groups of contiguous symbols, slots, subframes, etc.). When implementing time and/or frequency domain PRS stitching, the PRS should preferably be transmitted on multiple bandwidth intervals and/or time intervals such that the receiver can make certain assumptions about the PRS transmitted within the multiple slots and/or positioning frequency layers (e.g., QCL type, same antenna port, etc.).

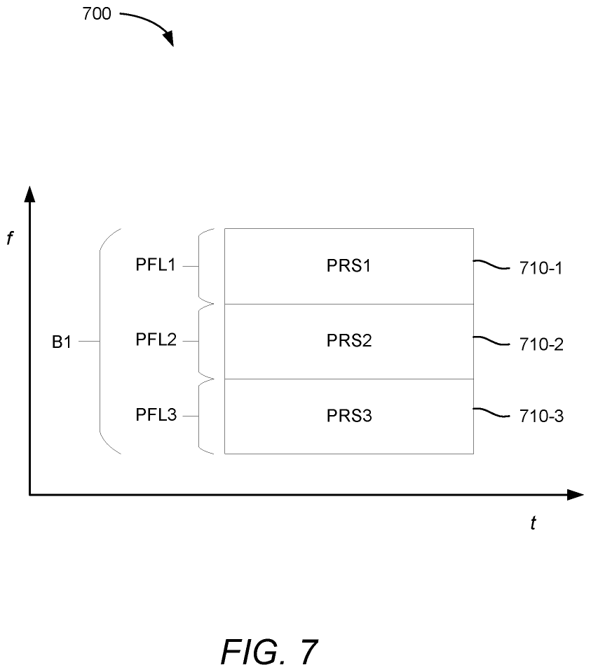

FIG. 7 is a diagram 700 of an example of frequency domain PRS stitching, according to aspects of the disclosure. As shown in FIG. 7, PRS 710-1, 710-2, and 710-3 (labeled “PRS1,” “PRS2,” and “PRS3,” respectively) are transmitted on respective positioning frequency layers (labeled “PFL1,” “PFL2,” and “PFL3,” respectively) within a given frequency band (labeled “B1”). The frequency band “B1” may be a frequency band in FR1 or FR2. The PRS 710 may be DL-PRS transmitted by a base station to one or more UEs, UL-PRS transmitted by a UE to one or more base stations, or sidelink PRS transmitted by a UE to one or more other UEs.

In FIG. 7, time is represented horizontally and frequency is represented vertically. Thus, in the example of FIG. 7, the three positioning frequency layers are contiguous in the frequency domain. Although FIG. 7 illustrates a single frequency band “B1,” the positioning frequency layers may instead span multiple frequency bands (possibly in both FR1 and FR2), with or without a guard band between the different frequency bands. Further, the positioning frequency layers may span one or more component carriers within the one or more frequency bands. In addition, while FIG. 7 illustrates PRS 710 transmitted on three positioning frequency layers, as will be appreciated, PRS 710 may be transmitted on only two positioning frequency layers or on more than three positioning frequency layers.

In the time domain, the PRS 710 may be PRS occasions, PRS resources, slots containing PRS, etc. The PRS 710 should generally be identical to each other except that they are transmitted on different positioning frequency layers. However, while the PRS 710 in FIG. 7 are illustrated as beginning and ending at the same time, this may not always be the case, and some PRS 710 may begin or end or have a different length than other PRS 710.

Using different positioning frequency layers (especially across different component carriers or frequency bands) for the transmission and reception of the PRS 710 introduces the issue of phase shift between the waveforms carrying the different PRS 710. Phase shift is the difference in phase, or phase difference, between two waveforms. Thus, for example, the phase of the waveform of PRS 710-2 may be slightly different than the phase of the waveform of PRS 710-1. Mathematically, the channel on which a first PRS (e.g., PRS 710-1) is transmitted can be represented as h (f,t1), where f represents frequency, t1 represents time, and h represents the channel as a function of frequency f and time t1. The channel on which a related PRS (e.g., a PRS to be stitched together with the first PRS, such as PRS 710-2) is transmitted can be represented as h(f,t1)·e\hat{ }jθ, where e\hat{ }jθ represents the phase shift, or phase difference, between the channel on which the first PRS is transmitted and the channel on which the related PRS is transmitted.

Phase shift can occur in both intra- and inter-band PRS (i.e., PRS on positioning frequency layers within the same component carrier or frequency band or PRS on positioning frequency layers within multiple component carriers or frequency bands). Phase shift is particularly noticeable when two signals (waveforms) are combined together by a physical process, such as by a receiver's analog front-end. However, phase shift can be caused by the architecture of both the transmitter and receiver. For example, any change in the transmit/receive RF chain may cause discontinuity in the phase of the PRS 710. A phase shift between the waveforms of PRS transmitted on multiple positioning frequency layers can cause additional measurement errors in the measurement estimation procedure (e.g., ToA estimation procedure), which lowers the positioning accuracy.

To facilitate position estimation of low-tier UEs such as RedCap UEs, PRS and/or SRS frequency hopping may be supported. For example, various parameters may be defined specific to RedCap UEs, such as, e.g.:
UL SRS for positioning to enable Tx frequency hopping, including but not limited to partial overlapping between hops, hopping bandwidth, time gap between frequency hopping.
DL PRS to enable Tx or Rx frequency hopping, including but not limited to impact on processing capability, hopping bandwidth in the positioning frequency layer, time gap between frequency hopping, measurement period, partial overlapping between hops.
TX/RX frequency hopping for positioning of RedCap UEs, the value of the gap between two consecutive hops includes at least from 100 us to 5 ms.
TX/RX frequency hopping for positioning of redcap UEs, the value of UE speed includes, e.g., 3 km/h, 30 km/h, 60 km/h.
From RANI perspective, for positioning of RedCap UEs, support of PRS frequency hopping and SRS frequency hopping.
Maximum tolerable phase error, timing gap, and timing error between hops
Parameters specific to IIoT, commercial, Public Safety and V2X scenarios, and UE capabilities
Tx or Rx hopping pattern(s), including frequency overlapping between hops, if supported.
RRM requirements for positioning including RRM measurements and procedures for RedCap UEs for both with and without frequency hopping [RAN4].

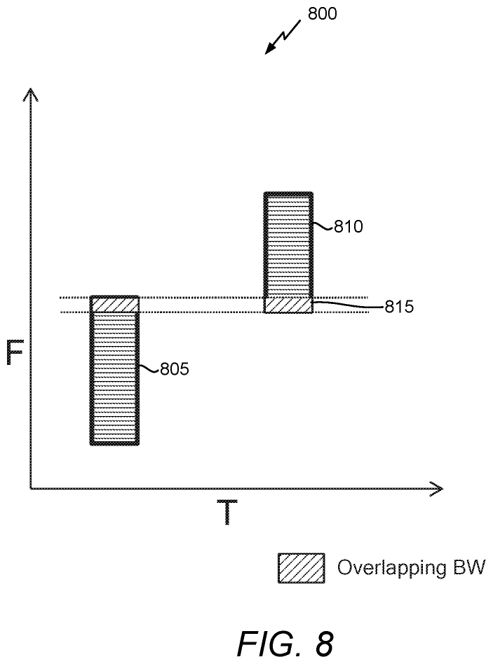

FIG. 8 illustrates a frequency hopping scheme 800 in accordance with an aspect of the disclosure. In FIG. 8, an RS for positioning (e.g., DL PRS or UL SRS) is processed (e.g., measured or transmitted) at a RedCap UE via a series of M hops. In particular, two of the M hops are illustrated in FIG. 8, with a first frequency hop 805 followed by a second frequency hop 810. In FIG. 8, an overlapping bandwidth (BW) 815 (e.g., guard tones, etc.) are configured among the resources associated with the first frequency hop 805 and the second frequency hop 810. Accurate phase offset estimation is possible using overlapping tones with a simple and low complexity algorithm parameter estimation is harder, but a compressive sensing approach is possible.

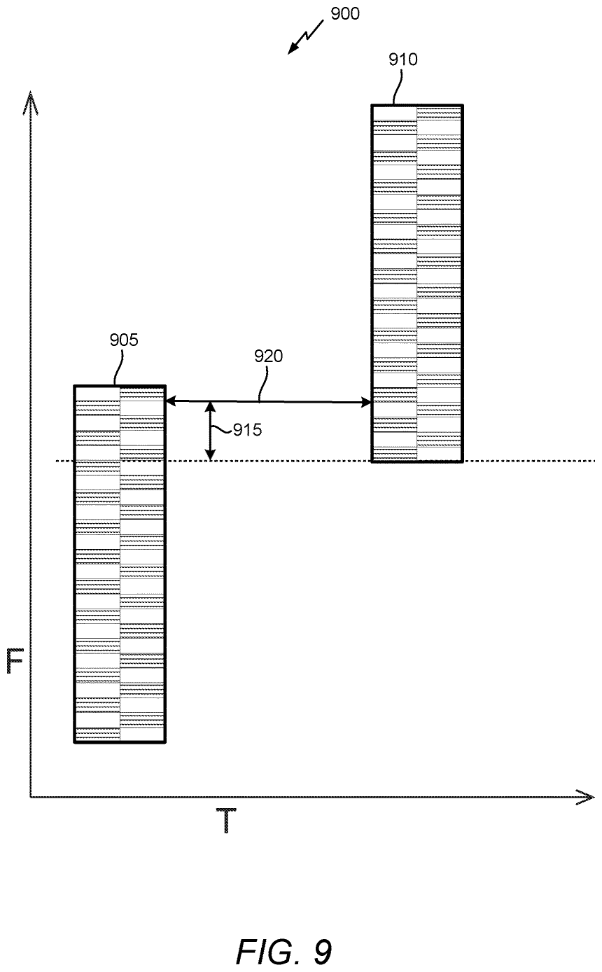

FIG. 9 illustrates a frequency hopping scheme 900 in accordance with another aspect of the disclosure. The frequency hopping scheme 900 is similar to the frequency hopping scheme 800, except each respective frequency hop (frequency hops 905 and 910) is depicted in more detail with respect to its comb pattern. In FIG. 9, an overlapping BW 915 (e.g., guard tones, etc.) are configured among the resources associated with the first frequency hop 905 and the second frequency hop 910. Also depicted is a switching gap 920 (or hop interval) 920.

Measurement gaps (MGs) are opportunities given to the UE to perform measurements on downlink signals. During an MG, UE cannot perform inter-frequency or inter-RAT measurements while also transmitting or receiving. Even for intra-frequency measurements, a 5G UE may require measurement gaps if such measurements are to be performed outside the UE's currently active Bandwidth Part (BWP). The network configures a UE with measurement gaps via RRC signaling. The network configures MGs so that the MGs do not coincide with UE transmissions or receptions. MGs may be periodic. A UE may be configured with multiple MGs. In some designs, UE RRC informs Layer 1 of MGs. In some designs, collected measurements are reported to the network either at Layer 1 or RRC. In some designs, PRS processing without measurement gaps (also referred to as “measurement gap-less” PRS processing, or “MG-less” PRS processing) whereby, subject to UE capability, PRS measurements may be outside of measurement gaps, within a PRS processing window (PPW).

In some designs, for MG-based DL-PRS processing, multiple retuning times inside the MG for positioning are defined. The maximum MG length is 20 msec, with 13 msec needed assuming a PRS instance of 2 msec and a legacy RF retuning time of as much as 500 usec.

In some designs, for MG-less PPW-based DL-PRS processing, DL-BWP switching approach and PPW configured in each BWP may be utilized. This has small impact to the relevant standard, but uses up to 4 BWPs in a CC, so 100 MHz of BW cannot be utilized and there is a larger BWP retuning time. In other designs, a single active DL-BWP is used, and a new switching mechanism may be utilized where only the RF center frequency changes.

In case of UEs in an RRC-Connected state, UL SRS (or SRS for positioning (SRS-P)) may be configured in an active bandwidth part (BWP) in various ways. In a first example, a UL-BWP switching approach may be utilized. In some designs, the UL-BWP switching approach may be associated with a large switching time and may only support up to 4 BWPs. In a second example, an SRS-P that is associated with the CC and not the active BWP may be defined. In some designs, SRS hopping using “SRS switching time for SRS carrier switching” may be a starting point, e.g., {Ous, 30 us, 100 us, 140 us, 200 us, 300 us, 500 us, 900 us}. In other designs, SRS hopping using the switching times of SRS transmission in RRC Inactive, e.g., {100 us, 140 us, 200 us, 300 us, 500 us}.

In some designs, SRS frequency resource configurations may depend on whether frequency hopping is enabled/disabled. For example, frequency hopping of the SRS may be configured by the parameter bₕₒₚ∈{0,1,2,3} given by the field b-hop contained in the higher-layer parameter freqHopping if configured, otherwise bₕₒₚ=0. If bₕₒₚ<B_{SRS} frequency hopping is enabled, otherwise if bₕₒₚ≥B_{SRS} then frequency hopping is disabled.

In some designs, when SRS is transmitted on a given SRS resource, the sequence r^{(pl)} (n, l′) for each OFDM symbol l′ and for each of the antenna ports of the SRS resource shall be multiplied with the amplitude scaling factor β_{SRS} in order to conform to the transmit power specified in and mapped in sequence starting with r^{(pi)} (0, l′) to resource elements (k, l) in a slot for each of the antenna ports pᵢ according to

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & \begin{matrix}{k}^{′} = 0 , 1 , … , {M}_{sc , b}^{SRS} - 1 \\ {l}^{′} = 0 , 1 , … , {N}_{symb}^{SRS} - 1\end{matrix} \\ 0 & otherwise\end{matrix}$$

In some designs, the length of the sounding reference signal sequence is given by

$${M}_{sc , b}^{SRS} = {m}_{SRS , b} {N}_{sc}^{RB} / ( {K}_{TC} {P}_{F} )$$

where m_{SRS,b} is given by a selected row of Table 1 (below) with b=B_{SRS} where B_{SRS} ∈{0,1,2,3} is given by the field b-SRS contained in the higher-layer parameter freqHopping if configured, otherwise B_{SRS}=0. The row of the table is selected according to the index C_{SRS}∈{0,1, . . . ,63} given by the field c-SRS contained in the higher-layer parameter freqHopping. The quantity P_{F}∈{2,4} is given by the higher-layer parameter FreqScalingFactor if configured, otherwise P_{F}=1. When FreqScalingFactor is configured, the UE expects the length of the SRS sequence to be a multiple of 6.

In some designs, the frequency-domain starting position

$${k}_{0}^{( {p}_{i} )}$$

is defined by

$${k}_{0}^{( {p}_{i} )} = {\overline{k}}_{0}^{( {p}_{i} )} + {n}_{offset}^{FH} + {n}_{offset}^{RPFS}$$

$$where$$

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC}$$

$${K}_{TC}^{( {p}_{i} )} = \{ \begin{matrix}( {\overline{k}}_{TC} + {K}_{TC} / 2 ) mod {K}_{TC} & \begin{matrix}if {N}_{ap}^{SRS} = 4 , {p}_{i} ∈ \{ 1001 , 1003 \} , \\ and {n}_{SRS}^{cs , max} = 6\end{matrix} \\ ( {\overline{k}}_{TC} + {K}_{TC} / 2 ) mod {K}_{TC} & \begin{matrix}if {N}_{ap}^{SRS} = 4 , {p}_{i} ∈ \{ 1001 , 1003 \} , \\ and {n}_{SRS}^{cs} ∈ \{ {n}_{SRS}^{cs , max} / 2 , … , {n}_{SRS}^{cs , max} - 1 \}\end{matrix} \\ {\overline{k}}_{TC} & otherwise\end{matrix}$$

$${n}_{offset}^{FH} = {\sum }_{b = 0}^{{B}_{SRS}} {m}_{SRS , b} {N}_{sc}^{R B} {n}_{b}$$

$${n}_{offset}^{RPFS} = {N}_{sc}^{R B} {m}_{SRS , {B}_{SRS}} ( ( {k}_{F} + {k}_{hop} ) mod {P}_{F} ) / {P}_{F}$$

and
k_{F}∈{0,1, . . . , P_{F}−1} is given by the higher-layer parameter StartRBIndex if configured, otherwise k_{F}=0;
kₕₒₚ is given by Table 1 (below) with

$${\overline{k}}_{hop} = ⌊ \frac{{n}_{SRS}}{{\prod }_{{b}^{′} = {b}_{hop}}^{{B}_{SRS}} {N}_{{b}^{′}}} ⌋ mod {P}_{F}$$

$${N}_{{b}_{hop}} = 1$$

if the higher-layer parameter EnableStartRBHopping is configured, otherwise kₕₒₚ=0.

In some designs, if

$${N}_{BWP}^{s tart} \leq {n}_{shift}$$

the reference point for

$${k}_{0}^{( {p}_{i} )} = 0$$

is subcarrier 0 in common resource block 0, otherwise the reference point is the lowest subcarrier of the BWP.

In some designs, the frequency domain shift value n_{shift} adjusts the SRS allocation with respect to the reference point grid and is contained in the higher-layer parameter freqDomainShift in the SRS-Resource IE or the SRS-PosResource IE. The transmission comb offset k̅_{TC}∈{0,1, . . . , K_{TC}−1} is contained in the higher-layer parameter transmissionComb in the SRS-Resource IE or the SRS-PosResource IE and n_{b} is a frequency position index.

In some designs, frequency hopping of the sounding reference signal is configured by the parameter bₕₒₚ ∈{0,1,2,3}, given by the field b-hop contained in the higher-layer parameter freqHopping if configured, otherwise bₕₒₚ=0.

In some designs, if bₕₒₚ≥B_{SRS}, frequency hopping is disabled and the frequency position index n_{b} remains constant (unless re-configured) and is defined by

$${n}_{b} = ⌊ 4 {n}_{RRC} / {m}_{SRS , b} ⌋ mod {N}_{b}$$

for all

$${N}_{symb}^{SRS}$$

OFDM symbols of the SRS resource. The quantity n_{RRC} is given by the higher-layer parameter freqDomainPosition if configured, otherwise n_{RRC=}0, and the values of m_{SRS,b} and N_{b} for b=B_{SRS} are given by the selected row of Table 1 (below) corresponding to the configured value of C_{SRS}.

In some designs, if bₕₒₚ<B_{SRS}, frequency hopping is enabled and the frequency position indices n_{b} are defined by

$${n}_{b} = \{ \begin{matrix}⌊ 4 {n}_{RRC} / {m}_{SRS , b} ⌋ mod {N}_{b} & b \leq {b}_{hop} \\ ( {F}_{b} ( {n}_{SRS} ) + ⌊ 4 {n}_{RRC} / {m}_{SRS , b} ⌋ ) mod {N}_{b} & otherwise\end{matrix}$$

$$where {N}_{b} is given by Table 1 ( below ) ,$$

$${F}_{b} ( {n}_{SRS} ) = \{ \begin{matrix}( {N}_{b} / 2 ) ⌊ \frac{{n}_{SRS} mod {\prod }_{{b}^{′} = {b}_{hop}}^{b - 1} {N}_{{b}^{′}}}{{\prod }_{{b}^{′} = {b}_{hop}}^{b - 1} {N}_{{b}^{′}}} ⌋ + ⌊ \frac{{n}_{SRS} mod {\prod }_{{b}^{′} = {b}_{hop}}^{b - 1} {N}_{{b}^{′}}}{2 {\prod }_{{b}^{′} = {b}_{hop}}^{b - 1} {N}_{{b}^{′}}} ⌋ & if {N}_{b} even \\ ⌊ {N}_{b} / 2 ⌋ ⌊ {n}_{SRS} / {\prod }_{{b}^{′} = {b}_{hop}}^{b - 1} {N}_{{b}^{′}} ⌋ & if {N}_{b} odd\end{matrix}$$

and where N_{b}_{ₕₒₚ}=1 regardless of the value of N_{b}. The quantity n_{SRS} counts the number of SRS transmissions. For the case of an SRS resource configured as aperiodic by the higher-layer parameter resourceType, it is given by n_{SRS}=└l′/R┘ within the slot in which the

$${N}_{symb}^{SRS}$$

symbol SRS resource is transmitted. The quantity

$$R \leq {N}_{symb}^{SRS}$$

is me reputation factor given by the field repetitionFactor if configured, otherwise

$$R = {N}_{symb}^{SRS} .$$

For the case of an SRS resource configured as periodic or semi-persistent by the higher-layer parameter resourceType, the SRS counter is given by

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R} ) + ⌊ \frac{{l}^{′}}{R} ⌋ ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R} ) + ⌊ \frac{{l}^{′}}{R} ⌋$$

for slots that satisfy

$$( {N}_{slot}^{frame , μ} {n}_{f} - {n}_{s , f}^{μ} - {T}_{offset} ) mod {T}_{SRS} = 0.$$

The periodicity T_{SRS} in slots and slot offset T_{offset} may be defined in the relevant standard.

Assume a maximum transmission BW for 30 KHz SCS is 51 PRBs (e.g., based on maximum transmission BW configuration in N_{RB} for FR1 as defined in the relevant standard). For SRS, the BW needs to be multiple of 4 PRBs (per the relevant standard). So, the maximum transmission is 48 PRBs. Under these assumptions, Row 55 in the SRS transmission table (Table 1) may be utilized, which covers a total of 240 PRBs with 5 hops, e.g.:

TABLE 1

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS, 0} | N₀ | m_{SRS, 1} | N₁ | m_{SRS, 2} | N₂ | m_{SRS, 3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4 | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1 | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

In Table 1, m_{SRS,n} is the number of RBs per hop, Nₙ is the number of hops per frequency hopping instances, and 2\hat{ }B_{SRS,n} is the number of frequency hopping instances. So, if B_{SRS}=0, there is a single frequency hopping instance, if B_{SRS}=1, there are two frequency hopping instances, and so on.

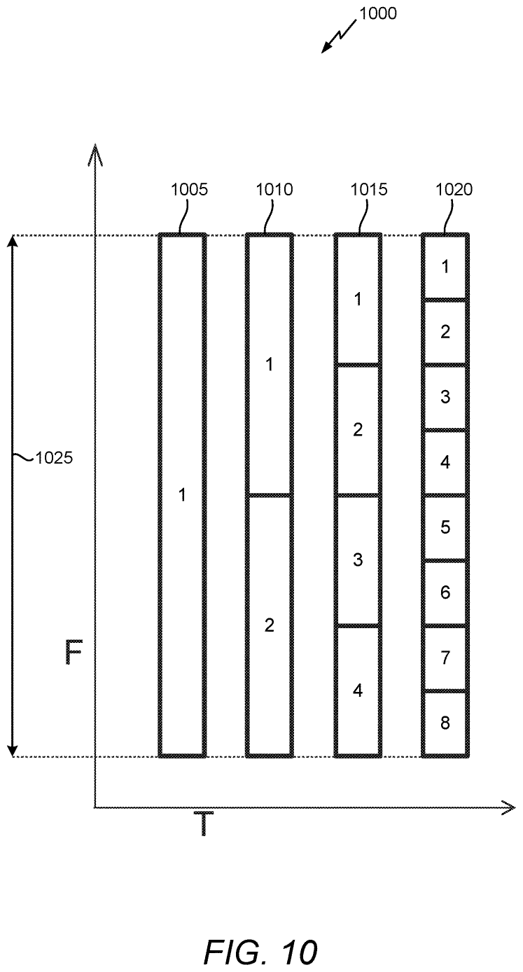

FIG. 10 illustrates a frequency hopping scheme 1000, in accordance with aspects of the disclosure. In FIG. 10, frequency hopping instances for four example RS-P (e.g., DL PRS or UL SRS) frequency hopping patterns of an RS-P configuration are depicted at 1005, 1010, 1015, and 1020. In this example, it is assumed that the RS-P configuration uses Row 55 of Table 1 (or C_{SRS}=1). Frequency hopping pattern 1005 corresponds to B_{SRS}=0, frequency hopping pattern 1010 corresponds to B_{SRS}=1, frequency hopping pattern 1015 corresponds to B_{SRS}=2, and frequency hopping pattern 1020 corresponds to B_{SRS}=3. While more frequency hopping instances are used as the value of B_{SRS} increases, the total BW 1025 of each RS-P resource remains the same. In some designs, each frequency hopping instance implements the same frequency hopping pattern, while being offset in frequency within the BW 1025.

In some designs, the individual frequency hops in each frequency hopping instance do not overlap with each other, which can introduce problems with phase tracking between frequency hops, and so on.

Aspects of the disclosure are directed to defining an overlap BW amount between frequency hops of respective frequency hopping instance(s) of an RS-P resource (e.g., DL PRS resource or UL SRS resource). Such aspects may provide various technical advantages, such as improved phase tracking between frequency hops which facilitates RS-P “stitching” so as to improve position estimation accuracy, latency, and so on, particularly for UE types such as RedCap UEs.

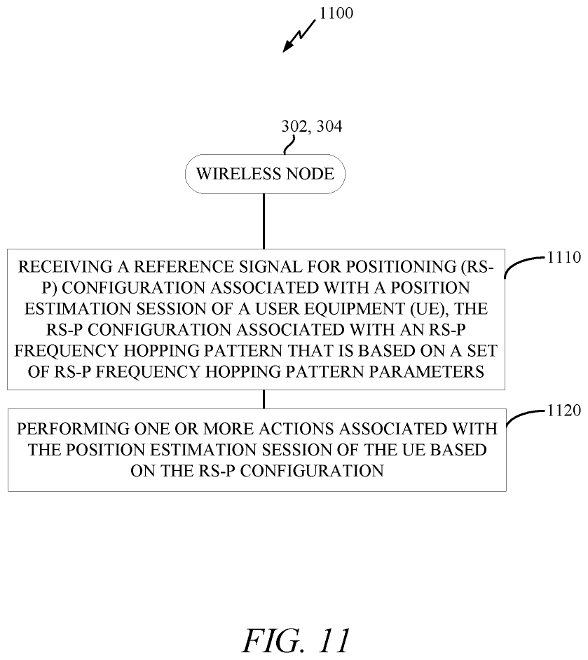

FIG. 11 illustrates an exemplary process 1100 of communications according to an aspect of the disclosure. The process 1100 of FIG. 11 is performed by a wireless node, such as a UE (e.g., UE 302) or a wireless-capable network component (e.g., gNB/BS 304 or O-RAN component, etc.).

Referring to FIG. 11, at 1110, UE 302 (e.g., receiver 312 or 322 or 352 or 362, network transceiver(s) 380, etc.) receives a reference signal for positioning (RS-P) configuration associated with a position estimation session of a user equipment (UE), the RS-P configuration associated with an RS-P frequency hopping pattern that is based on a set of RS-P frequency hopping pattern parameters. In some designs, the RS-P frequency hopping pattern comprises a single RS-P frequency hopping pattern instance or a plurality of RS-P frequency hopping pattern instances that are associated with the same bandwidth (BW) and are offset from each other in frequency domain. In some designs, the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level. In some designs, the set of RS-P frequency hopping pattern parameters comprises an indication of one of the multiple hierarchical levels, a number of frequency hops per RS-P frequency hopping instance, and an amount of BW per frequency hop. In some designs, a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount. In some designs, the RS-P frequency hopping pattern hierarchy may be based on the value of B_{SRS}, with each valid value of B_{SRS} (e.g., 0, 1, 2, 3, etc.) corresponding to a respective hierarchical level.

Referring to FIG. 11, at 1110, UE 302 (e.g., receiver 312 or 322 or 352 or 362, transmitter 314 or 324 or 354 or 354, network transceiver(s) 380, processor(s) 332 or 384, frequency hopping module 342 or 388, etc.) performs one or more actions associated with the position estimation session of the UE based on the RS-P configuration.

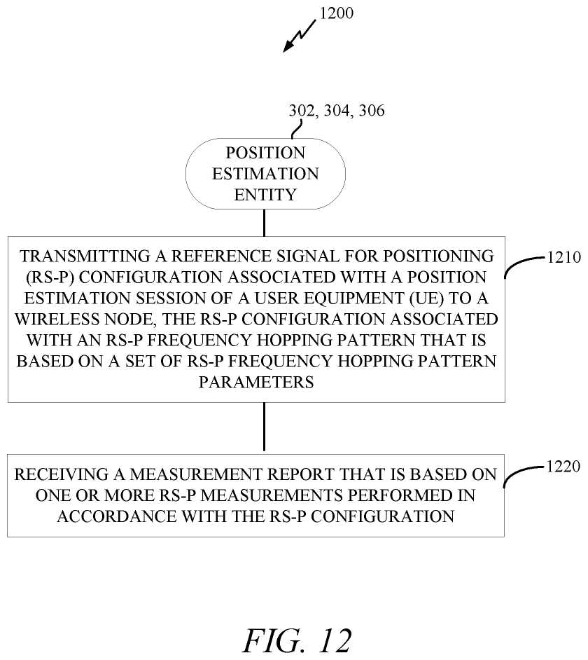

FIG. 12 illustrates an exemplary process 1200 of communications according to an aspect of the disclosure. The process 1200 of FIG. 12 is performed by a position estimation entity. In some designs, the position estimation entity may correspond to a network component (e.g., an LMF integrated at gNB/BS 304 or O-RAN component or a remote location search such as network entity 306, etc.). In other designs, the position estimation entity may correspond to another UE (e.g., sidelink anchor UE) or to the target UE itself (e.g., for UE-based position estimation, in which case any Rx/Tx operations between the UE and the position estimation entity may correspond to transfer of information between different logical components of the UE over a data bus, etc.).

Referring to FIG. 12, at 1210, the position estimation entity (e.g., transmitter 314 or 324 or 354 or 364, data bus 334 or 382, network transceiver(s) 380 or 390, data bus 334, etc.) transmits a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters. In some designs, the RS-P frequency hopping pattern comprises a single RS-P frequency hopping pattern instance or a plurality of RS-P frequency hopping pattern instances that are associated with the same bandwidth (BW) and are offset from each other in frequency domain. In some designs, the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level. In some designs, the set of RS-P frequency hopping pattern parameters comprises an indication of one of the multiple hierarchical levels, a number of frequency hops per RS-P frequency hopping instance, and an amount of BW per frequency hop. In some designs, a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount. In some designs, the RS-P frequency hopping pattern hierarchy may be based on the value of BRS, with each valid value of B_{SRS} (e.g., 0, 1, 2, 3, etc.) corresponding to a respective hierarchical level.

Referring to FIG. 12, at 1220, the position estimation entity (e.g., receiver 312 or 322 or 352 or 362, data bus 334 or 382, network transceiver(s) 380 or 390, data bus 334, etc.) receives a measurement report that is based on one or more RS-P measurements performed in accordance with the RS-P configuration.

Referring to FIGS. 11-12, in some designs, the RS-P frequency hopping pattern comprises the single RS-P frequency hopping pattern instance.

Referring to FIGS. 11-12, in some designs, the RS-P frequency hopping pattern comprises the plurality of RS-P frequency hopping pattern instances.

Referring to FIGS. 11-12, in some designs, a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or the number of RS-P frequency hopping pattern instances for the indicated hierarchical level is 5, the number of frequency hops per RS-P frequency hopping instance is 5, and the amount of BW per frequency hop corresponds to 48 PRBs, or the number of RS-P frequency hopping pattern instances for the indicated hierarchical level is 15, the number of frequency hops per RS-P frequency hopping instance is 3, and the amount of BW per frequency hop corresponds to 16 PRBs, or the number of RS-P frequency hopping pattern instances for the indicated hierarchical level is 30, the number of frequency hops per RS-P frequency hopping instance is 2, and the amount of BW per frequency hop corresponds to 8 PRBs. As will be appreciated, the above-noted options generally map to Table 1 (above), whereby C_{SRS}=1 and B_{SRS}=0, 1, 2 and 3, respectively.

Referring to FIGS. 11-12, in some designs, the overlap BW amount is defined in units of tones or physical resource blocks (PRBs) (e.g., 1 or 2 or 3 tones, or 1 or 2 or 3 PRBs or RBs, etc.).

Referring to FIGS. 11-12, in some designs, the RS-P configuration comprises a downlink (DL) positioning reference signal (PRS) configuration, a sidelink (SL) PRS configuration, or both. In some designs, the one or more actions include performing one or more DL PRS measurements, or one or more SL PRS measurements, or both, in accordance with the RS-P configuration, and transmitting a measurement report based on the one or more DL PRS measurements, or one or more SL PRS measurements, or both.

Referring to FIGS. 11-12, in some designs, the wireless node corresponds to the UE or a network entity.

$${k}_{0}^{( {p}_{i} )}$$

is defined by

$${k}_{0}^{( {p}_{i} )} = {\overline{k}}_{0}^{( {p}_{i} )} + {\sum }_{b = 0}^{{B}_{SRS}} ( {K}_{TC} {M}_{sc , b}^{SRS} {n}_{b} - {M}_{overlap} \cdot {n}_{b} \cdot {\prod }_{{b}^{′} = b + 1}^{{B}_{PRS}} {N}_{{b}^{′}} )$$

where Mₒᵥₑᵣₗₐₚ is the number of tones of frequency overlap of 2 frequency-adjacent hops.

In this example, the remaining aspects on the hopping specification remain as defined in the relevant standard, while the component of

$${M}_{overlap} \cdot {n}_{b} \cdot {\prod }_{{b}^{′} = b + 1}^{{B}_{PRS}} {N}_{{b}^{′}}$$

is new. This component may define an overlap BW between adjacent frequency hops (in frequency domain rather than time domain) in each frequency hopping instance associated with the RS-P resource. In some designs, frequency-domain overlap may occur on non-time-domain-adjacent hops. In this case, in some designs, there may be some impact to mobility and doppler variations, and no multiplexing across SRS-MIMO and SRS-POS.

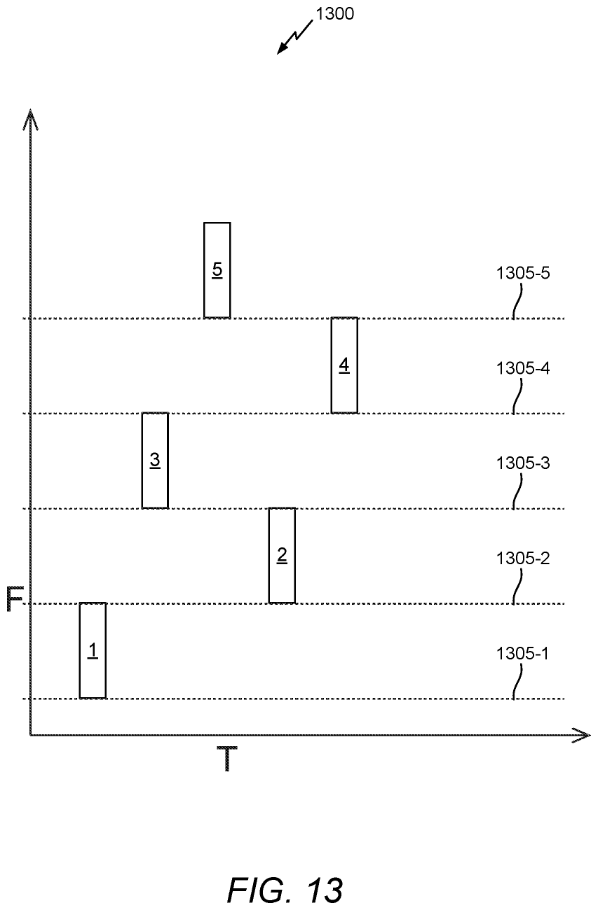

FIG. 13 illustrates a frequency hopping pattern 1300, in accordance with aspects of the present disclosure.

Referring to FIG. 13, the frequency hopping pattern 1300 constitutes at least part of a frequency hopping pattern associated with a particular frequency hopping instance. For example, the frequency hopping pattern 1300 may correspond to an RS-P configuration that uses Row 55 of Table 1, whereby C_{SRS}=1 and B_{SRS}=1. In FIG. 13, hops 1-5 are depicted, which have starting frequencies denoted as 1305-1, 1305-2, 1305-3, 1305-4 and 1305-5, respectively. As shown in FIG. 13, the hops 1-5 are adjacent in frequency domain (not time domain). In frequency domain, the hops 1-5 do not overlap, as evidenced by the starting frequencies 1305-1, 1305-2, 1305-3, 1305-4 and 1305-5.

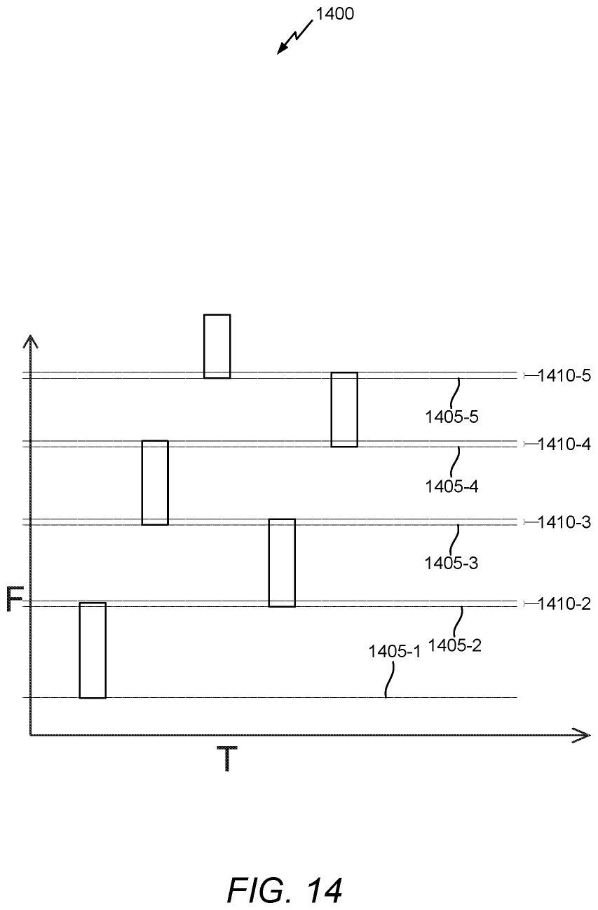

FIG. 14 illustrates a frequency hopping pattern 1400 associated with an example implementation of the processes 1100-1200 of FIGS. 11-12, respectively, in accordance with aspects of the present disclosure.

Referring to FIG. 14, the frequency hopping pattern 1400 constitutes at least part of a frequency hopping pattern associated with a particular frequency hopping instance. For example, the frequency hopping pattern 1300 may correspond to an RS-P configuration that uses Row 55 of Table 1, whereby C_{SRS}=1 and B_{SRS}=1. In FIG. 14, hops 1-5 are depicted, which have starting frequencies denoted as 1405-1, 1405-2, 1405-3, 1405-4 and 1405-5, respectively. As shown in FIG. 14, the hops 1-5 are adjacent in frequency domain (not time domain). In frequency domain, the hops 1-5 overlap, as evidenced by the starting frequencies 1405-1, 1405-2, 1405-3, 1405-4 and 1405-5. In particular, hops 1-2 overlap in BW 1410-2, hops 2-3 overlap in BW 1410-3, hops 3-4 overlap in BW 1410-4, and hops 4-5 overlap in BW 1410-5. To facilitate these overlaps, each successive frequency hop (in frequency domain) has a lower BW as a function of, as an example, the

$${M}_{overlap} \cdot {n}_{b} \cdot {\prod }_{{b}^{′} = b + 1}^{{B}_{PRS}} {N}_{{b}^{′}}$$

component, as discussed above.

While FIGS. 13-14 are described in a scenario whereby C_{SRS}=1 and B_{SRS}=1, it will be readily appreciated that this example scenario can be extended to other scenarios such as whereby C_{SRS}=1 and B_{SRS}=2 or C_{SRS}=1 and B_{SRS}=3, and so on (e.g., with a different number of frequency hops or RBs per hop or frequency hopping instances or a different amount of overlap BW between frequency hops, and so on).

Referring to FIGS. 11-12, in some designs, the RS-P configuration comprises an uplink (UL) sounding reference signal (SRS) configuration, a sidelink (SL) positioning reference signal (PRS) configuration, or both. In some designs, the one or more actions include performing one or more UL SRS transmissions, or one or more SL PRS transmissions, or both, in accordance with the RS-P configuration. In some designs, the wireless node further receives (and the position estimation entity further transmits) a downlink (DL) positioning reference signal (PRS) configuration, the DL PRS configuration associated a PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain. In some designs, the DL PRS frequency hopping pattern and the RS-P frequency hopping pattern are implemented during a measurement gap (MG). In some designs, the DL PRS frequency hopping pattern and the RS-P frequency hopping pattern are implemented during a PRS processing window (PPW). A more detailed example of this aspect will now be described.

In some designs, a Processing & Transmission Window (e.g., MG where SRS is allowed to be transmitted, or PRS within PPW) may be introduced, in which both the DL-PRS and the SRS are being hopped with exactly the same formula. For example, the frequency-domain starting position

$${k}_{0}^{( {p}_{i} )}$$

for FRS is defined by

$${k}_{0}^{( {p}_{i} )} = {\overline{k}}^{( {p}_{i} )} + {\sum }_{b = 0}^{{B}_{PRS}} ( {K}_{TC} {M}_{sc , b}^{PRS} {n}_{b} - {M}_{overlap} \cdot {n}_{b} \cdot {\prod }_{{b}^{′} = b + 1}^{{B}_{PRS}} {N}_{{b}^{′}} )$$

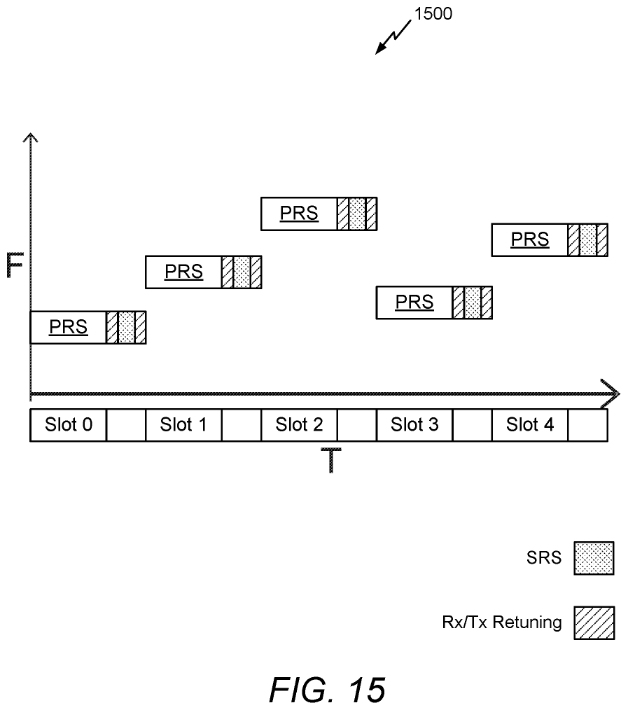

In some designs, the serving gNB configures the parameters to enable the PRS hopping, and these are configured in the same way as the corresponding SRS parameters. In some designs, the LMF recommends/requests specific hopping parameters (following the formula shown above) that apply to both PRS or SRS, or recommends/requests the hopping parameters separately. An example of this aspect is described below with respect to FIG. 15.

FIG. 15 illustrates a SRS-PRS-coupled frequency hopping scheme 1500 associated with an example implementation of the processes 1100-1200 of FIGS. 11-12, respectively, in accordance with aspects of the present disclosure. In FIG. 15, each PRS resource frequency hop is coupled to an associated SRS resource frequency hop. The SRS-PRS-coupled frequency hopping scheme 1500 is an example of a common processing and transmission window where both PRS and SRS are being hopped in the same manner and the RF retuning is happening only once for each hop.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of operating a wireless node, comprising: receiving a reference signal for positioning (RS-P) configuration associated with a position estimation session of a user equipment (UE), the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and performing one or more actions associated with the position estimation session of the UE based on the RS-P configuration.

Clause 2. The method of clause 1, wherein the RS-P frequency hopping pattern comprises the single RS-P frequency hopping pattern instance.

Clause 3. The method of any of clauses 1 to 2, wherein the RS-P frequency hopping pattern comprises the plurality of RS-P frequency hopping pattern instances.

Clause 4. The method of any of clauses 1 to 3, wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

Clause 5. The method of any of clauses 1 to 4, wherein the overlap BW amount is defined in units of tones or physical resource blocks (PRBs).

Clause 6. The method of any of clauses 1 to 5, wherein the RS-P configuration comprises a downlink (DL) positioning reference signal (PRS) configuration, a sidelink (SL) PRS configuration, or both.

Clause 7. The method of clause 6, wherein the one or more actions include performing one or more DL PRS measurements, or one or more SL PRS measurements, or both, in accordance with the RS-P configuration, and transmitting a measurement report based on the one or more DL PRS measurements, or one or more SL PRS measurements, or both.

Clause 8. The method of any of clauses 1 to 7, wherein the RS-P configuration comprises an uplink (UL) sounding reference signal (SRS) configuration, a sidelink (SL) positioning reference signal (PRS) configuration, or both.

Clause 9. The method of clause 8, wherein the one or more actions include performing one or more UL SRS transmissions, or one or more SL PRS transmissions, or both, in accordance with the RS-P configuration.

Clause 10. The method of any of clauses 8 to 9, further comprising: receiving a downlink (DL) positioning reference signal (PRS) configuration, the DL PRS configuration associated a DL PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain.

Clause 11. The method of clause 10, wherein the DL PRS frequency hopping pattern and the RS-P frequency hopping pattern are implemented during a measurement gap (MG).

Clause 12. The method of any of clauses 10 to 11, wherein the DL PRS frequency hopping pattern and the RS-P frequency hopping pattern are implemented during a DL PRS processing window (PRS).

Clause 13. The method of any of clauses 1 to 12, wherein the wireless node corresponds to the UE or a network entity.

Clause 14. A method of operating a position estimation entity, comprising: transmitting a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and receiving a measurement report that is based on one or more RS-P measurements performed in accordance with the RS-P configuration.

Clause 15. The method of clause 14, wherein the RS-P frequency hopping pattern comprises the single RS-P frequency hopping pattern instance.

Clause 16. The method of any of clauses 14 to 15, wherein the RS-P frequency hopping pattern comprises the plurality of RS-P frequency hopping pattern instances.

Clause 17. The method of any of clauses 14 to 16, wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

Clause 18. The method of any of clauses 14 to 17, wherein the overlap BW amount is defined in units of tones or physical resource blocks (PRBs).

Clause 19. The method of any of clauses 14 to 18, wherein the RS-P configuration comprises a downlink (DL) positioning reference signal (PRS) configuration, a sidelink (SL) PRS configuration, or both.

Clause 20. The method of any of clauses 14 to 19, wherein the RS-P configuration comprises an uplink (UL) sounding reference signal (SRS) configuration, a sidelink (SL) positioning reference signal (PRS) configuration, or both.

Clause 21. The method of clause 20, further comprising: transmitting a downlink (DL) positioning reference signal (PRS) configuration, the DL PRS configuration associated a DL PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain.

Clause 22. The method of clause 21, wherein the DL PRS frequency hopping pattern and the RS-P frequency hopping pattern are implemented during a measurement gap (MG).

Clause 23. The method of any of clauses 21 to 22, wherein the DL PRS frequency hopping pattern and the RS-P frequency hopping pattern are implemented during a DL PRS processing window (PRS).

Clause 24. The method of any of clauses 14 to 23, wherein the wireless node corresponds to the UE or a network entity.

Clause 25. A wireless node, comprising: a memory; and at least one processor communicatively coupled to the memory, the at least one processor configured to: receive a reference signal for positioning (RS-P) configuration associated with a position estimation session of a user equipment (UE), the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and perform one or more actions associated with the position estimation session of the UE based on the RS-P configuration.

Clause 26. The wireless node of clause 25, wherein the RS-P frequency hopping pattern comprises the single RS-P frequency hopping pattern instance.

Clause 27. The wireless node of any of clauses 25 to 26, wherein the RS-P frequency hopping pattern comprises the plurality of RS-P frequency hopping pattern instances.

Clause 28. The wireless node of any of clauses 25 to 27, wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

Clause 29. The wireless node of any of clauses 25 to 28, wherein the overlap BW amount is defined in units of tones or physical resource blocks (PRBs).

Clause 30. The wireless node of any of clauses 25 to 29, wherein the RS-P configuration comprises a downlink (DL) positioning reference signal (PRS) configuration, a sidelink (SL) PRS configuration, or both.

Clause 31. The wireless node of clause 30, wherein the one or more actions include performing one or more DL PRS measurements, or one or more SL PRS measurements, or both, in accordance with the RS-P configuration, and transmitting a measurement report based on the one or more DL PRS measurements, or one or more SL PRS measurements, or both.

Clause 32. The wireless node of any of clauses 25 to 31, wherein the RS-P configuration comprises an uplink (UL) sounding reference signal (SRS) configuration, a sidelink (SL) positioning reference signal (PRS) configuration, or both.

Clause 33. The wireless node of clause 32, wherein the one or more actions include performing one or more UL SRS transmissions, or one or more SL PRS transmissions, or both, in accordance with the RS-P configuration.

Clause 34. The wireless node of any of clauses 32 to 33, wherein the at least one processor is further configured to: receive a downlink (DL) positioning reference signal (PRS) configuration, the DL PRS configuration associated a DL PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain.

Clause 35. The wireless node of clause 34, wherein the DL PRS frequency hopping pattern and the RS-P frequency hopping pattern are implemented during a measurement gap (MG).

Clause 36. The wireless node of any of clauses 34 to 35, wherein the DL PRS frequency hopping pattern and the RS-P frequency hopping pattern are implemented during a DL PRS processing window (PRS).

Clause 37. The wireless node of any of clauses 25 to 36, wherein the wireless node corresponds to the UE or a network entity.

Clause 38. A position estimation entity, comprising: a memory; and at least one processor communicatively coupled to the memory, the at least one processor configured to: transmit a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and receive a measurement report that is based on one or more RS-P measurements performed in accordance with the RS-P configuration.

Clause 39. The position estimation entity of clause 38, wherein the RS-P frequency hopping patter comprises the single RS-P frequency hopping pattern instance.

Clause 40. The position estimation entity of any of clauses 38 to 39, wherein the RS-P frequency hopping pattern comprises the plurality of RS-P frequency hopping pattern instances.

Clause 41. The position estimation entity of any of clauses 38 to 40, wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

Clause 42. The position estimation entity of any of clauses 38 to 41, wherein the overlap BW amount is defined in units of tones or physical resource blocks (PRBs).

Clause 43. The position estimation entity of any of clauses 38 to 42, wherein the RS-P configuration comprises a downlink (DL) positioning reference signal (PRS) configuration, a sidelink (SL) PRS configuration, or both.

Clause 44. The position estimation entity of any of clauses 38 to 43, wherein the RS-P configuration comprises an uplink (UL) sounding reference signal (SRS) configuration, a sidelink (SL) positioning reference signal (PRS) configuration, or both.

Clause 45. The position estimation entity of clause 44, wherein the at least one processor is further configured to: transmit a downlink (DL) positioning reference signal (PRS) configuration, the DL PRS configuration associated a DL PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain.

Clause 46. The position estimation entity of clause 45, wherein the DL PRS frequency hopping pattern and the RS-P frequency hopping pattern are implemented during a measurement gap (MG).

Clause 47. The position estimation entity of any of clauses 45 to 46, wherein the DL PRS frequency hopping pattern and the RS-P frequency hopping pattern are implemented during a DL PRS processing window (PRS).

Clause 48. The position estimation entity of any of clauses 38 to 47, wherein the wireless node corresponds to the UE or a network entity.

Clause 49. A wireless node, comprising: means for receiving a reference signal for positioning (RS-P) configuration associated with a position estimation session of a user equipment (UE), the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and means for performing one or more actions associated with the position estimation session of the UE based on the RS-P configuration.

Clause 50. The wireless node of clause 49, wherein the RS-P frequency hopping pattern comprises the single RS-P frequency hopping pattern instance.

Clause 51. The wireless node of any of clauses 49 to 50, wherein the RS-P frequency hopping pattern comprises the plurality of RS-P frequency hopping pattern instances.

Clause 52. The wireless node of any of clauses 49 to 51, wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

Clause 53. The wireless node of any of clauses 49 to 52, wherein the overlap BW amount is defined in units of tones or physical resource blocks (PRBs).

Clause 54. The wireless node of any of clauses 49 to 53, wherein the RS-P configuration comprises a downlink (DL) positioning reference signal (PRS) configuration, a sidelink (SL) PRS configuration, or both.

Clause 55. The wireless node of clause 54, wherein the one or more actions include performing one or more DL PRS measurements, or one or more SL PRS measurements, or both, in accordance with the RS-P configuration, and transmitting a measurement report based on the one or more DL PRS measurements, or one or more SL PRS measurements, or both.

Clause 56. The wireless node of any of clauses 49 to 55, wherein the RS-P configuration comprises an uplink (UL) sounding reference signal (SRS) configuration, a sidelink (SL) positioning reference signal (PRS) configuration, or both.

Clause 57. The wireless node of clause 56, wherein the one or more actions include performing one or more UL SRS transmissions, or one or more SL PRS transmissions, or both, in accordance with the RS-P configuration.

Clause 58. The wireless node of any of clauses 56 to 57, further comprising: means for receiving a downlink (DL) positioning reference signal (PRS) configuration, the DL PRS configuration associated a DL PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain.

Clause 59. The wireless node of clause 58, wherein the DL PRS frequency hopping pattern and the RS-P frequency hopping pattern are implemented during a measurement gap (MG).

Clause 60. The wireless node of any of clauses 58 to 59, wherein the DL PRS frequency hopping pattern and the RS-P frequency hopping pattern are implemented during a DL PRS processing window (PRS).

Clause 61. The wireless node of any of clauses 49 to 60, wherein the wireless node corresponds to the UE or a network entity.

Clause 62. A position estimation entity, comprising: means for transmitting a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and means for receiving a measurement report that is based on one or more RS-P measurements performed in accordance with the RS-P configuration.

Clause 63. The position estimation entity of clause 62, wherein the RS-P frequency hopping patter comprises the single RS-P frequency hopping pattern instance.

Clause 64. The position estimation entity of any of clauses 62 to 63, wherein the RS-P frequency hopping pattern comprises the plurality of RS-P frequency hopping pattern instances.

Clause 65. The position estimation entity of any of clauses 62 to 64, wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

Clause 66. The position estimation entity of any of clauses 62 to 65, wherein the overlap BW amount is defined in units of tones or physical resource blocks (PRBs).

Clause 67. The position estimation entity of any of clauses 62 to 66, wherein the RS-P configuration comprises a downlink (DL) positioning reference signal (PRS) configuration, a sidelink (SL) PRS configuration, or both.

Clause 68. The position estimation entity of any of clauses 62 to 67, wherein the RS-P configuration comprises an uplink (UL) sounding reference signal (SRS) configuration, a sidelink (SL) positioning reference signal (PRS) configuration, or both.

Clause 69. The position estimation entity of clause 68, further comprising: means for transmitting a downlink (DL) positioning reference signal (PRS) configuration, the DL PRS configuration associated a DL PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain.

Clause 70. The position estimation entity of clause 69, wherein the DL PRS frequency hopping pattern and the RS-P frequency hopping pattern are implemented during a measurement gap (MG).

Clause 71. The position estimation entity of any of clauses 69 to 70, wherein the DL PRS frequency hopping pattern and the RS-P frequency hopping pattern are implemented during a DL PRS processing window (PRS).

Clause 72. The position estimation entity of any of clauses 62 to 71, wherein the wireless node corresponds to the UE or a network entity.

Clause 73. A non-transitory computer-readable medium storing computer-executable instructions that, when executed by a wireless node, cause the wireless node to: receive a reference signal for positioning (RS-P) configuration associated with a position estimation session of a user equipment (UE), the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and perform one or more actions associated with the position estimation session of the UE based on the RS-P configuration.

Clause 74. The non-transitory computer-readable medium of clause 73, wherein the RS-P frequency hopping pattern comprises the single RS-P frequency hopping pattern instance.

Clause 75. The non-transitory computer-readable medium of any of clauses 73 to 74, wherein the RS-P frequency hopping pattern comprises the plurality of RS-P frequency hopping pattern instances.

Clause 76. The non-transitory computer-readable medium of any of clauses 73 to 75, wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

Clause 77. The non-transitory computer-readable medium of any of clauses 73 to 76, wherein the overlap BW amount is defined in units of tones or physical resource blocks (PRBs).

Clause 78. The non-transitory computer-readable medium of any of clauses 73 to 77, wherein the RS-P configuration comprises a downlink (DL) positioning reference signal (PRS) configuration, a sidelink (SL) PRS configuration, or both.

Clause 79. The non-transitory computer-readable medium of clause 78, wherein the one or more actions include performing one or more DL PRS measurements, or one or more SL PRS measurements, or both, in accordance with the RS-P configuration, and transmitting a measurement report based on the one or more DL PRS measurements, or one or more SL PRS measurements, or both.

Clause 80. The non-transitory computer-readable medium of any of clauses 73 to 79, wherein the RS-P configuration comprises an uplink (UL) sounding reference signal (SRS) configuration, a sidelink (SL) positioning reference signal (PRS) configuration, or both.

Clause 81. The non-transitory computer-readable medium of clause 80, wherein the one or more actions include performing one or more UL SRS transmissions, or one or more SL PRS transmissions, or both, in accordance with the RS-P configuration.

Clause 82. The non-transitory computer-readable medium of any of clauses 80 to 81, further comprising computer-executable instructions that, when executed by the wireless node, cause the wireless node to: receive a downlink (DL) positioning reference signal (PRS) configuration, the DL PRS configuration associated a DL PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain.

Clause 83. The non-transitory computer-readable medium of clause 82, wherein the DL PRS frequency hopping pattern and the RS-P frequency hopping pattern are implemented during a measurement gap (MG).

Clause 84. The non-transitory computer-readable medium of any of clauses 82 to 83, wherein the DL PRS frequency hopping pattern and the RS-P frequency hopping pattern are implemented during a DL PRS processing window (PRS).

Clause 85. The non-transitory computer-readable medium of any of clauses 73 to 84, wherein the wireless node corresponds to the UE or a network entity.

Clause 86. A non-transitory computer-readable medium storing computer-executable instructions that, when executed by a position estimation entity, cause the position estimation entity to: transmit a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters, wherein the RS-P frequency hopping pattern comprises a single RS-P frequency hopping pattern instance or a plurality of RS-P frequency hopping pattern instances that are associated with the same bandwidth (BW) and are offset from each other in frequency domain, wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level, wherein the set of RS-P frequency hopping pattern parameters comprises an indication of one of the multiple hierarchical levels, a number of frequency hops per RS-P frequency hopping instance, and an amount of BW per frequency hop, wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and receive a measurement report that is based on one or more RS-P measurements performed in accordance with the RS-P configuration.

Clause 87. The non-transitory computer-readable medium of clause 86, wherein the RS-P frequency hopping pattern comprises the single RS-P frequency hopping pattern instance.

Clause 88. The non-transitory computer-readable medium of any of clauses 86 to 87, wherein the RS-P frequency hopping pattern comprises the plurality of RS-P frequency hopping pattern instances.

Clause 89. The non-transitory computer-readable medium of any of clauses 86 to 88, wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

Clause 90. The non-transitory computer-readable medium of any of clauses 86 to 89, wherein the overlap BW amount is defined in units of tones or physical resource blocks (PRBs).

Clause 91. The non-transitory computer-readable medium of any of clauses 86 to 90, wherein the RS-P configuration comprises a downlink (DL) positioning reference signal (PRS) configuration, a sidelink (SL) PRS configuration, or both.

Clause 92. The non-transitory computer-readable medium of any of clauses 86 to 91, wherein the RS-P configuration comprises an uplink (UL) sounding reference signal (SRS) configuration, a sidelink (SL) positioning reference signal (PRS) configuration, or both.

Clause 93. The non-transitory computer-readable medium of clause 92, further comprising computer-executable instructions that, when executed by the position estimation entity, cause the position estimation entity to: transmit a downlink (DL) positioning reference signal (PRS) configuration, the DL PRS configuration associated a DL PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain.

Clause 94. The non-transitory computer-readable medium of clause 93, wherein the DL PRS frequency hopping pattern and the RS-P frequency hopping pattern are implemented during a measurement gap (MG).

Clause 95. The non-transitory computer-readable medium of any of clauses 93 to 94, wherein the DL PRS frequency hopping pattern and the RS-P frequency hopping pattern are implemented during a DL PRS processing window (PRS).

Clause 96. The non-transitory computer-readable medium of any of clauses 86 to 95, wherein the wireless node corresponds to the UE or a network entity.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of operating a wireless node, comprising:
receiving a reference signal for positioning (RS-P) configuration associated with a position estimation session of a user equipment (UE), the RS-P configuration associated with an RS-P frequency hopping pattern that is based on a set of RS-P frequency hopping pattern parameters,
wherein the RS-P frequency hopping pattern comprises a single RS-P frequency hopping pattern instance or a plurality of RS-P frequency hopping pattern instances that are associated with the same bandwidth (BW) and are offset from each other in frequency domain,
wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level,
wherein the set of RS-P frequency hopping pattern parameters comprises an indication of one of the multiple hierarchical levels, a number of frequency hops per RS-P frequency hopping instance, and an amount of BW per frequency hop,
wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and performing one or more actions associated with the position estimation session of the UE based on the RS-P configuration.

2. The method of claim 1, wherein the RS-P frequency hopping pattern comprises the single RS-P frequency hopping pattern instance.

3. The method of claim 1, wherein the RS-P frequency hopping pattern comprises the plurality of RS-P frequency hopping pattern instances.

4. The method of claim 1,
wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or
wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

5. The method of claim 1, wherein the overlap BW amount is defined in units of tones or physical resource blocks (PRBs).

6. The method of claim 1, wherein the RS-P configuration comprises a downlink (DL) positioning reference signal (PRS) configuration, a sidelink (SL) PRS configuration, or both.

7. The method of claim 6, wherein the one or more actions include performing one or more DL PRS measurements, or one or more SL PRS measurements, or both, in accordance with the RS-P configuration, and transmitting a measurement report based on the one or more DL PRS measurements, or one or more SL PRS measurements, or both.

8. The method of claim 1, wherein the RS-P configuration comprises an uplink (UL) sounding reference signal (SRS) configuration, a sidelink (SL) positioning reference signal (PRS) configuration, or both.

9. The method of claim 8, wherein the one or more actions include performing one or more UL SRS transmissions, or one or more SL PRS transmissions, or both, in accordance with the RS-P configuration.

10. The method of claim 8, further comprising:
receiving a downlink (DL) positioning reference signal (PRS) configuration, the DL PRS configuration associated a DL PRS frequency hopping pattern that is coupled to the RS-P frequency hopping pattern such that a DL PRS resource for respective DL PRS frequency hop and a UL SRS resource for a respective corresponding SRS frequency hop occur in the same slot and overlap in the frequency domain.

11. The method of claim 10, wherein the DL PRS frequency hopping pattern and the RS-P frequency hopping pattern are implemented during a measurement gap (MG).

12. The method of claim 10, wherein the DL PRS frequency hopping pattern and the RS-P frequency hopping pattern are implemented during a DL PRS processing window (PRS).

13. The method of claim 1, wherein the wireless node corresponds to the UE or a network entity.

14-24. (canceled)

25. A wireless node, comprising:
a memory; and
at least one processor communicatively coupled to the memory, the at least one processor configured to:
receive a reference signal for positioning (RS-P) configuration associated with a position estimation session of a user equipment (UE), the RS-P configuration associated with an RS-P frequency hopping pattern that is based on a set of RS-P frequency hopping pattern parameters,
wherein the RS-P frequency hopping pattern comprises a single RS-P frequency hopping pattern instance or a plurality of RS-P frequency hopping pattern instances that are associated with the same bandwidth (BW) and are offset from each other in frequency domain,
wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level,
wherein the set of RS-P frequency hopping pattern parameters comprises an indication of one of the multiple hierarchical levels, a number of frequency hops per RS-P frequency hopping instance, and an amount of BW per frequency hop,
wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and perform one or more actions associated with the position estimation session of the UE based on the RS-P configuration.

26. The wireless node of claim 25,
wherein a number of RS-P frequency hopping pattern instances for the indicated hierarchical level is 1, the number of frequency hops per RS-P frequency hopping instance
is 1, and the amount of BW per frequency hop corresponds to 240 physical resource blocks (PRBs), or
wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

27. The wireless node of claim 25,
wherein the RS-P configuration comprises a downlink (DL) positioning reference signal (PRS) configuration, or
wherein the RS-P configuration comprises an uplink (UL) sounding reference signal (SRS) configuration, or
wherein the RS-P configuration comprises a sidelink (SL) positioning reference signal (PRS) configuration, or
any combination thereof.

28. A position estimation entity, comprising:
a memory; and
at least one processor communicatively coupled to the memory, the at least one processor configured to:
transmit a reference signal for positioning (RS-P) configuration associated with a position estimation session of a user equipment (UE) to a wireless node, the RS-P configuration associated with an RS-P frequency hopping pattern that is based on a set of RS-P frequency hopping pattern parameters,
wherein the RS-P frequency hopping pattern comprises a single RS-P frequency hopping pattern instance or a plurality of RS-P frequency hopping pattern instances that are associated with the same bandwidth (BW) and are offset from each other in frequency domain,
wherein the RS-P frequency hopping pattern is associated with a RS-P frequency hopping pattern hierarchy that includes multiple hierarchical levels, with each successive hierarchical level associated with a higher number of RS-P frequency hopping pattern instances that each include a lower BW relative to each RS-P frequency hopping pattern instance of a preceding hierarchical level,
wherein the set of RS-P frequency hopping pattern parameters comprises an indication of one of the multiple hierarchical levels, a number of frequency hops per RS-P frequency hopping instance, and an amount of BW per frequency hop,
wherein a starting frequency of each successive frequency hop per RS-P frequency hopping instance is offset so as to overlap with a respective preceding frequency hop by an overlap BW amount based on (i) an RS-P frequency hopping instance index, (ii) a frequency hop index, and (iii) the overlap BW amount; and receive a measurement report that is based on one or more RS-P measurements performed in accordance with the RS-P configuration.

29. The position estimation entity of claim 28,
wherein a number of RS-P frequency hopping pattern instances for the indicated hierarchical level is 1, the number of frequency hops per RS-P frequency hopping instance is 1, and the amount of BW per frequency hop corresponds to 240 physical resource blocks (PRBs), or
wherein the number of RS-P frequency hopping pattern instances for the indicated hierarchical level is 5, the number of frequency hops per RS-P frequency hopping instance is 5, and the amount of BW per frequency hop corresponds to 48 PRBs, or wherein the number of RS-P frequency hopping pattern instances for the indicated hierarchical level is 15, the number of frequency hops per RS-P frequency hopping instance is 3, and the amount of BW per frequency hop corresponds to 16 PRBs, or wherein the number of RS-P frequency hopping pattern instances for the indicated hierarchical level is 30, the number of frequency hops per RS-P frequency hopping instance is 2, and the amount of BW per frequency hop corresponds to 8 PRBs.

30. The position estimation entity of claim 28,
wherein the RS-P configuration comprises a downlink (DL) positioning reference signal (PRS) configuration, or
wherein the RS-P configuration comprises an uplink (UL) sounding reference signal (SRS) configuration, or
wherein the RS-P configuration comprises a sidelink (SL) positioning reference signal (PRS) configuration, or
any combination thereof.
